(19) United States
(12) Patent Application Publication
(10) Pub. No.: US 2008/0068159 A1
(43) Pub. Date: Mar. 20, 2008

(54) Alarm Indicator

(76) Inventors: Robert Bradus, Bel Air, MD (US); Charles P. Mooney, Dallastown, PA (US)

Correspondence Address: THE BLACK & DECKER CORPORATION, 701 EAST JOPPA ROAD, TW199, TOWSON, MD, 21286, US

(21) Appl. No.: 11/853,254

(22) Filed: Sep. 11, 2007

Related U.S. Application Data
(60) Provisional application No. 60/826,232, filed on Sep. 20, 2006.

(51) Int. Cl. G08B 21/00

(52) U.S. Cl. 340/540

(57) ABSTRACT

An alarm system includes a first alarm indicator and a circuit configured to detect an indicator from the first alarm indicator and to generate a signal n response to activation for the first alarm indicator. The alarm system may also have a second alarm indicator configured and arranged to receive the signal from the circuit to activate the second alarm indicator.

### TECHNICAL FIELD

This description relates to an alarm indicator.

### BACKGROUND

In an alarm system, it may be desirable to provide an indication of an alarm signal that is separated from a central alarm unit.

### SUMMARY

In one general aspect, an alarm system includes a first alarm indicator, a circuit that is configured and arranged to detect an indicator from the first alarm indicator and to generate a signal in response to activation of the first alarm indicator and a second alarm indicator that is configured and arranged to receive the signal from the circuit to activate the second alarm indicator.

Implementations may include one or more of the following features. For example, the first alarm indicator may be a first siren and the indicator may be a sound from the first siren and the circuit may be a sound activated circuit that is configured and arranged to detect the sound from the first siren. The second alarm indicator may be a second siren that is configured and arranged to receive the signal from the sound activated circuit to activate the second siren. The second alarm indicator may be a strobe that is configured and arranged to receive the signal from the sound activated circuit to activate the strobe. The second alarm indicator may be a combined siren and strobe that is configured and arranged to receive the signal from the sound activated circuit to activate the strobe. The sound activated circuit may include a microphone that is configured and arranged to detect the sound from the first siren.

In another exemplary implementation, the first alarm indicator may be a first strobe and the indicator may be a light from the first strobe and the circuit may be a light activated circuit that is configured and arranged to detect the light from the first strobe. The second alarm indicator may be a second strobe that is configured and arranged to receive the signal from the light activated circuit to activate the second strobe. The second alarm indicator may be a siren that is configured and arranged to receive the signal from the light activated circuit to activate the siren. The second alarm indicator may be a combined siren and strobe that is configured and arranged to receive the signal from the light activated circuit to activate the combined siren and strobe. The light activated circuit may include a photodetector to detect the light from the first strobe.

Other features will be apparent from the description, the drawings, and the claims.

### DESCRIPTION OF DRAWINGS

FIG. 1 is a block diagram of an exemplary alarm system.

FIG. 2 is a block diagram of an exemplary alarm system.

FIG. 3 is a block diagram of an exemplary alarm system.

FIG. 4 is a block diagram of an exemplary control circuit.

FIG. 5 is a block diagram of an exemplary control circuit.

FIG. 6 is a flow chart of an exemplary control logic process.

Like reference symbols in the various drawings indicate like elements.

### DETAILED DESCRIPTION

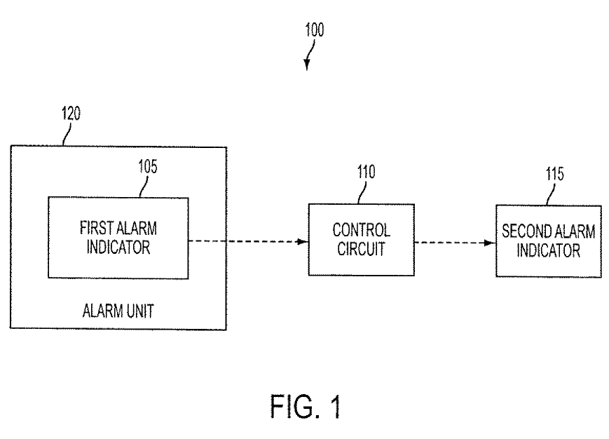

Referring to FIG. 1, an exemplary alarm system 100 may include a first alarm indicator 105, a control circuit 110 and a second alarm indicator 115. The first alarm indicator 105 may include a siren, a strobe, a combined siren and strobe, or any other type of alarm notification device. For example, the first alarm indicator 105 may be a part of an alarm unit 120 such that when the alarm unit 120 is activated, the first alarm indicator 105 is activated. For instance, if the first alarm indicator 105 is a siren, then the siren will sound when the alarm unit 120 is activated. The siren may be for use indoors and/or outdoors. If the first alarm indicator 105 is a strobe, then the strobe will flash when the alarm unit 120 is activated. If the first alarm indicator 105 is a combined siren and strobe, then the siren will sound and the strobe will flash when the alarm unit 120 is activated.

The control circuit 110 may be configured to detect an indicator from the first alarm indicator 105 when the first alarm indicator 105 is activated. For example, the control circuit 110 may include a sound activated relay that is configured and arranged to detect the indicator (e.g., the sound) from the first alarm indicator. In response to detecting the indicator from the first alarm indicator, the control circuit 110 generates a signal and communicates the signal to the second alarm indicator 115. The control circuit may be wired and/or wirelessly configured to communicate the signal to the second alarm indicator 115.

In one exemplary implementation, the control circuit 110 may include a microphone that is used to detect the sound from the first alarm indicator 105 and a circuit that is configured and arranged to separate out the sound from the first alarm indicator 105 from other noises. In another exemplary implementation, the microphone may be separate from the control circuit 110.

The second alarm indicator 115 may include a siren, a strobe, a combined siren and strobe, or any other type of alarm notification device. The second alarm indicator 115 may be configured to receive the signal generated by the control circuit 110 that triggers the generation of the alarm. The signal from the control circuit 110 may provide power for the second alarm indicator 115. For example, if the second alarm indicator 115 is a siren, then the siren will sound when the signal is received from the control circuit 110. If the second alarm indicator 115 is a strobe, then the strobe will flash when the signal is received from the control circuit 110. If the second alarm indicator 115 is a combined siren and strobe, then the siren will sound and the strobe will flash when the signal is received from the control circuit 110. The second alarm indicator 115 may be configured to receive the signal from the control circuit 110 using wired and/or wireless communications.

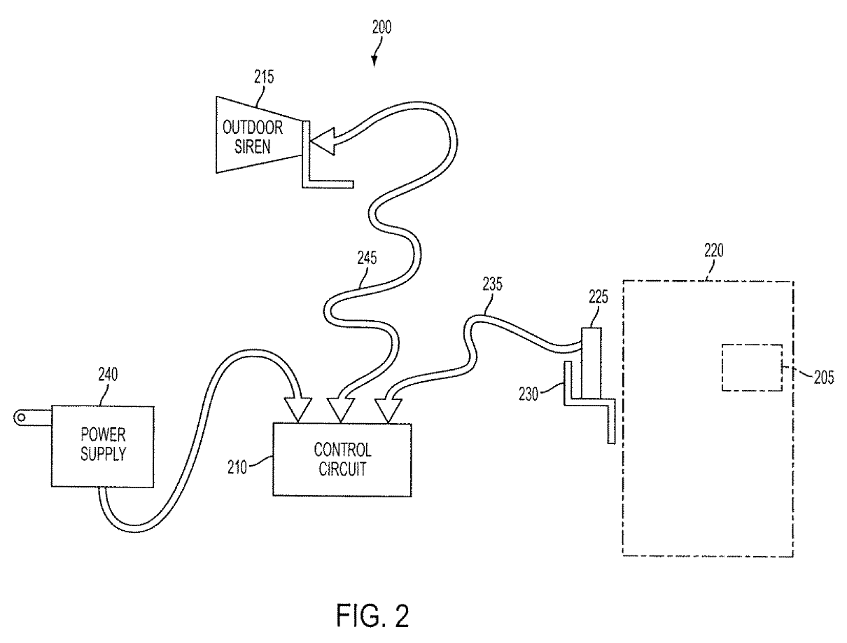

Referring to FIG. 2, an exemplary alarm system 200 is illustrated. Alarm system 200 includes a first alarm indicator that is shown as an internal siren 205, a control circuit 210, and a second alarm indicator that is shown as an outdoor siren 215. The internal siren 205 is incorporated as part of alarm unit 220, which may be, for example, a DeWALT® DS100 Jobsite Security Portable Alarm System (Base Unit). When the internal siren 205 sounds, an external microphone 225 detects the sound from the internal siren 205 and communicates the sound to control circuit 210. A mounting bracket 230 may be used to place the microphone 225 near the alarm unit 220 so that the sound from the internal siren 205 may be picked up. A cable 235 may be used to connect the microphone 225 to the control circuit 210.

The control circuit 210 may receive power from a power supply 240. The control circuit 210 receives the alarm sound from microphone 225 and is configured and arranged to distinguish between the alarm sound and other noises. The control circuit 210 may be housed in a housing, which may be a thermoplastic enclosure. The housing may have one or more connection points for the cable 235, power supply 240 and cable 245, which connects the control circuit 210 and the outdoor siren 215. The control circuit 210 may include a “Power On” light emitting device (LED) to indicate when power is applied to the control circuit 210. Cable 235 and cable 245 may be of any length. For example, in one implementation, cables 235 and 245 may be from less than 1 foot to greater than 25 feet in length. When the control circuit 210 receives the alarm sound from the microphone 225, the control circuit applies a signal and provides power to sound outdoor siren 215. Outdoor siren 215 may be enclosed in a weather resistant enclosure.

In another exemplary implementation, power supply 240 may be included within the housing for the control circuit 210 with a standard plug and cord coming out of the housing.

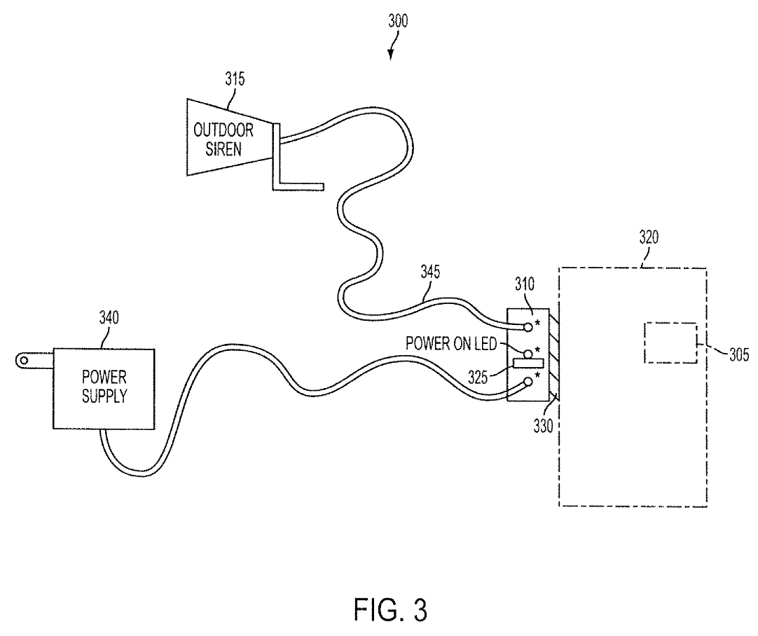

Referring to FIG. 3, an exemplary alarm system 300 is illustrated. Alarm system 300 includes a first alarm indicator that is illustrated as an internal siren 305, a control circuit 310 that includes an internal microphone 325, and a second alarm indicator that is illustrated as an outdoor siren 315. A power supply 340 provides power to the control circuit 310 and a cable 345 connects the control circuit 310 and the outdoor siren 315. The internal siren 305 is incorporated as part of alarm unit 320, which may be, for example, a DeWALT® DS100 Jobsite Security Portable Alarm System (Base Unit).

In alarm system 300, the control circuit 310 is enclosed in a housing that is attached to alarm unit 320 by an attachment means 330. In this example, the attachment means 330 may include a hook and loop type fastening arrangement. Other attachment means may be used. When the internal siren 305 sounds, the microphone 325 detects the alarm sound and communicates the alarm sound to the control circuit 310. The control circuit 310 then generates a signal and provides a power signal to power the outdoor siren 315 through cable 345.

In another exemplary implementation, power supply 340 may be included within the housing for the control circuit 310 with a standard plug and cord coming out of the housing.

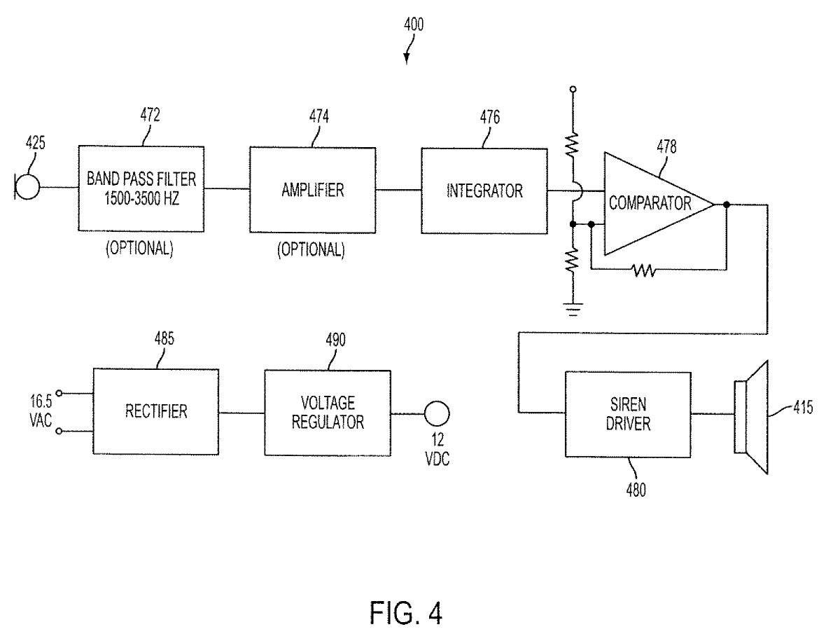

Referring to FIG. 4, a block diagram of an exemplary control circuit 400 is illustrated. A microphone 425 is used to detect sound from the first alarm indicator. In other exemplary implementations, the microphone may be replaced by a photodetector to detect light, if the first alarm indicator is a strobe or other light signal. Control circuit 400 includes an optional band pass filter 472, an optional amplifier 474, an integrator 476, a comparator 478, and a siren driver 480. Sound is received from the microphone at the band pass filter 472. The band pass filter 472 may be used to filter out extraneous noise so that the second alarm indicator 415 is not powered based upon an extraneous noise signal. Band pass filter 472 may not be needed is the signal-to-noise ratio of siren sound versus extraneous noise is adequate. If needed, the siren sound frequency is amplified by amplifier 474 and integrated by integrator 476. The integrator 476 may be used to eliminate affects of very brief signals or the absence of a signal. The integrated signal then goes to a comparator 478. When the integrated signal exceeds a configurable threshold, then the comparator 478 provides a signal to signal driver 480, which provides power to the second alarm indicator 415. The siren driver 480 may be a transistor, a field effect transistor (FET), or a relay.

A rectifier 485 may be a traditional 4-diode bridge. A voltage regulator 490 may be a linear regulator such as an LM317 produced by National Semiconductor or Fairchild Semiconductor. The design also may include a bus capacitor (not shown) between the rectifier 485 and voltage regulator 490, and filter capacitors (not shown) on one or both sides of the voltage regulator 490.

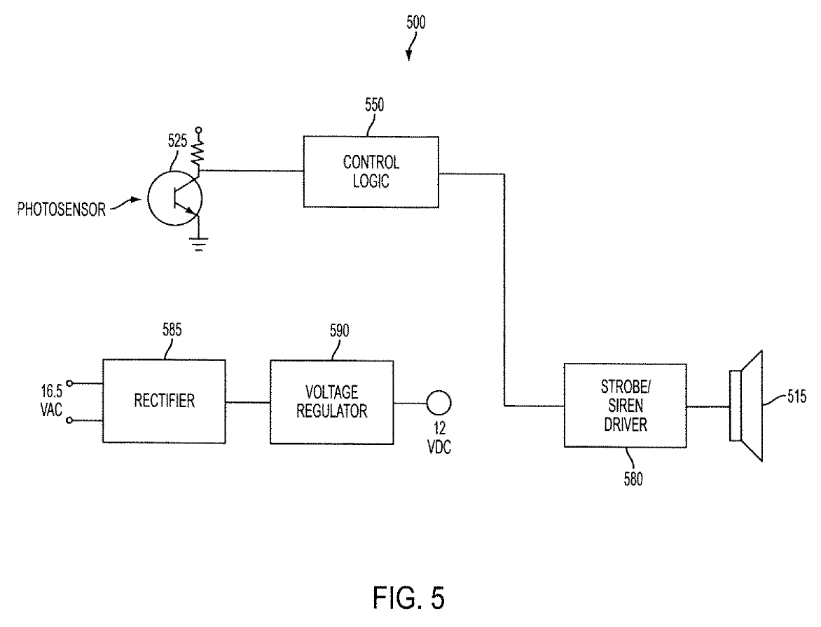

Referring to FIG. 5, a block diagram of an exemplary control circuit 500 is illustrated. A photosensor 525 is used to detect flashes from the first alarm indicator when the first alarm indicator is a strobe or other light signal. The photosensor may be a phototransistor, CdS photocell or other means of detecting light. The photosensor passes a signal to control logic 550. Control logic 550 determines if the flashes received by the photosensor 525 should trigger and strobe and/or siren driver 580 drive a second alarm indicator, such as strobe and/or siren 515. Control logic 550 is used to detect and distinguish a flash from the strobe over other ambient light. The strobe and/or siren driver 580 may be a transistor, a field effect transistor (FET), or a relay. The rectifier 585 may be a traditional 4-diode bridge. The voltage regulator 590 may be a linear regulator such as an LM317 produced by National Semiconductor or Fairchild Semiconductor. The design would also include a bus capacitor (not shown) between the rectifier 585 and voltage regulator 590, and filter capacitors (not shown) on one or both sides of the voltage regulator 590.

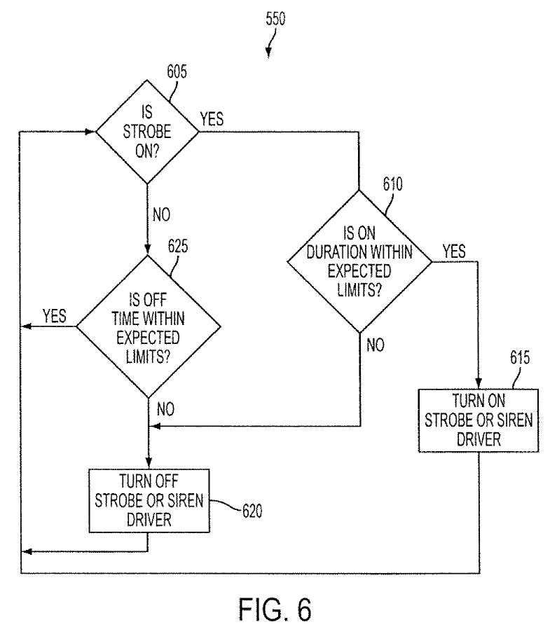

Referring to FIG. 6, exemplary control logic 550 is described. Control logic 550 determines if the first alarm indicator (e.g., a strobe) is on (605). If the strobe is on, then it is determined whether the strobe flash lasts for a duration within expected time limits (610). If the strobe flash is on within the expected time limits, then the strobe/siren driver is turned on (615). If light is detected, but not within the expected time limits, then the strobe/siren driver is turned off (620), as the light source is not the strobe. If the strobe is not on, then it is determined whether the strobe is off within expected time limits (625). If the strobe is off within the expected time limits, then the process repeats to determine whether the strobe is on (605). If the strobe is not off within the expected time limits, then the strobe/siren driver is turned off (620)

Other implementations are within the scope of the following claims.

What is claimed is:

1. An alarm system, comprising:
a first alarm indicator;
a circuit that is configured and arranged to detect an indicator from the first alarm indicator and to generate a signal in response to activation of the first alarm indicator; and
a second alarm indicator that is configured and arranged to receive the signal from the circuit to activate the second alarm indicator.

2. The alarm system of claim 1 wherein:
the first alarm indicator is a first siren and the indicator is a sound from the first siren; and
the circuit is a sound activated circuit that is configured and arranged to detect the sound from the first siren.

3. The alarm system of claim 2 wherein the second alarm indicator is a second siren that is configured and arranged to receive the signal from the sound activated circuit to activate the second siren.

4. The alarm system of claim 2 wherein the second alarm indicator is a strobe that is configured and arranged to receive the signal from the sound activated circuit to activate the strobe.

5. The alarm system of claim 2 wherein the second alarm indicator is a combined siren and strobe that is configured and arranged to receive the signal from the sound activated circuit to activate the strobe.

6. The alarm system of claim 2 wherein the sound activated circuit includes a microphone that is configured and arranged to detect the sound from the first siren.

7. The alarm system of claim 1 wherein:
the first alarm indicator is a first strobe and the indicator is a light from the first strobe; and
the circuit is a light activated circuit that is configured and arranged to detect the Tight from the first strobe.

8. The alarm system of claim 7 wherein the second alarm indicator is a second strobe that is configured and arranged to receive the signal from the light activated circuit to activate the second strobe.

9. The alarm system of claim 7 wherein the second alarm indicator is a siren that is configured and arranged to receive the signal from the light activated circuit to activate the siren.

10. The alarm system of claim 7 wherein the second alarm indicator is a combined siren and strobe that is configured and arranged to receive the signal from the light activated circuit to activate the combined siren and strobe.

11. The alarm system of claim 7 wherein the light activated circuit includes a photodetector to detect the light from the first strobe.
